(19) United States
(12) Patent Application Publication
(10) Pub. No.: US 2009/0310975 A1
(43) Pub. Date: Dec. 17, 2009

(54) ADAPTIVE DISPERSION COMPENSATION SYSTEM AND METHOD FOR OPTICAL COMMUNICATION NETWORK

(76) Inventor: Huade Shu, Shenzhen (CN)

Correspondence Address: CHRISTOPHER P. MAIORANA, P.C., 24840 HARPER SUITE 100, ST. CLAIR SHORES, MI, 48080, US

(21) Appl. No.: 12/487,109

(22) Filed: Jun. 18, 2009

Related U.S. Application Data
(63) Continuation of application No. PCT/CN2006/003528, filed on Dec. 21, 2006.

(51) Int. Cl. H04B 10/12

(52) U.S. Cl. 398/147

(57) ABSTRACT

The present invention discloses an adaptive dispersion compensation system and a method used in optical communication network, comprising at least one performance detecting unit (20), for detecting the dispersion relevant performances; at least one control processing unit (30), for generating control information according to the detected information from the at least one performance detecting unit (20); at least one dispersion adjusting unit (40), for compensating dispersion according to the control information from the at least one control processing unit (30); and an information transmission unit (50) which is connected among the at least one performance detecting unit, the at least one control processing unit and the at least one dispersion adjusting unit which are located at different nodes, the information transmission unit is used for transmitting the detected information from the at least one performance detecting unit to the at least one control processing unit which is located at a different node, and is used for transmitting the control information from the at least one control processing unit to the at least one dispersion adjusting unit which is located at a different node. Under the circumstance that the units are arranged at different nodes, the adaptive dispersion compensation to multichannel system or single channel system is realized.

This is a continuation of International Application PCT/CN2006/003528, with an International Filing date of Dec. 21, 2006.

### FIELD OF THE INVENTION

The present invention relates to optical transmission technology, in particular to an adaptive dispersion compensation system and a method used in optical communication network.

### BACKGROUND OF THE INVENTION

With the rapid development of the optical communication technology, the optical communication system develops along the trends of high speed, large capacity, long distance and intelligence and so on. At present, 160 channels dense wavelength division multiplexing (DMDM) optical communication system with 10 Gb/s speed per channel has been commercialized, and the automatically switched optical network (ASON) system based on intelligent circuit switching has also been commercialized. The optical network systems with larger capacity and higher speed (40 Gb/s and above) will appear in the future. In the meanwhile, the intelligent optical network system with optical cross function or optical-add drop multiplexing function will also appear.

In super-high speed optical transmission system, the dispersion and polarization mode dispersion will result in the deterioration of the quality of optical signals, and can decrease the transmission distance. In order to increase the transmission distance of the optical transmission system, measures need to be taken to compensate the dispersion and the polarization mode dispersion. In the traditional optical communication system, a fixed dispersion compensator is used to compensate the dispersion on lines as shown in FIG. 1. By means of dispersion compensation, the residual dispersion of the optical signal at the receiving side is ensured to be controlled within the tolerable range of a receiver. Generally, a dispersion compensation optical fiber module is used as the dispersion compensator. For the long-distance optical transmission system, the factors such as temperature, pressure and so on can result in the subtle change of the line optical fiber dispersion coefficient, and therefore the real-time change of the dispersion value of the light signal in the optical path will be accumulated continuously with the increase of the total transmission distance, which may result in the signal residual dispersion at receiving side exceeds the tolerable range, and consequently the error performance of the system will be deteriorated.

With the increase of the single channel speed, the dispersion tolerance of the light source is consequently decreased. For 10 Gb/s optical signal without pre-chirp, the dispersion tolerance value is about 1000 ps/nm; while for the 40 Gb/s optical signal without pre-chirp, the dispersion tolerance value is about 40 ps/nm, which only equals to 2 km transmission distance of G.652 optical fiber within 1550 nm wavelength window. Therefore, for the 40 Gb/s system, since the dispersion accommodation value of the light source is small, the subtle change of the line optical fiber dispersion value may possibly cause that the signal residual dispersion at receiving side exceeds the tolerable range, and the system error code performance will be deteriorated accordingly. As described above, the influence to the performance of 40 Gb/s system due to the change of the optical fiber dispersion is particularly obvious.

On the other hand, with the intellectualized development of the optical network, the reconfigurable optical add/drop multiplexing, even the optical cross-connect node will be brought into the optical network. The dynamic add/drop multiplexing and the dynamic cross-connect of the optical signals among the optical network nodes will bring the change of the dispersion value of the optical signal in optical path, which may cause the signal residual dispersion at receiving side exceed the tolerable range, and the system error code performance will be deteriorated accordingly.

In a word, the factors show that with the optical network develops towards the directions of high speed, long distance and intelligence, since the change of the dispersion values of lines and the optical network nodes, the signal residual dispersion value at the receiving side is caused to change continuously after the optical signals are transmitted in the lines. The adaptive dispersion compensation is necessary for the signals with continuously changeable residual dispersion values. How to realize the adaptive compensation is one of the key issues in the technical field.

The dispersion adjusting unit of the adaptive dispersion compensation system can be accomplished by using a tunable dispersion compensator. The dispersion compensation function of the tunable dispersion compensator can be realized in optical domain and also can be realized in electrical domain. The methods to realize the tunable dispersion compensation in optical domain are many, including various methods by using chirped fiber Bragg grating technology, interference technology based on Gires-Tournois etalon and multistage dispersion compensation module connected in series and so on. The methods to realize the tunable dispersion compensation in electrical domain are also many. After being processed by photoelectric conversion and linear amplification, the optical signal is sent to an equalization circuit. The performances of an equalizer are fed back through detecting the quality of equalized electrical signals and using some a control strategy to realize the adaptive dispersion compensation. The equalization circuit used by the dispersion compensation in electrical domain can be FFE (Feed-forward equalizer), DFE (Decision Feedback Equalizer), FDTS (Fixed Delay Tree Search), or MLSE (Maximum Likihood Sequence Estimation) and so on, or the combination of the pluralities of methods.

By detecting the signal quality of the residual dispersion or relevant with the dispersion in the front of the receiver, such as Q factor and so on (as shown in FIG. 2), or by detecting the relevant signal performance at the back of the receiver, such as bit error rate and so on (as shown in FIG. 3), the adaptive dispersion compensation can be realized by feeding back and controlling the signals.

In terms of functional module, the adaptive dispersion compensation function consists of three parts: a performance detecting unit, a control processing unit and a dispersion adjusting unit which are relevant with the dispersion, as shown in FIG. 4. Many methods can be used to realize the adaptive dispersion compensation, but mainly realized at one node. For the dynamic optical network, the above three units can be located at different nodes. When the three units are located at different nodes, in order to realize the performance of adaptive dispersion compensation, relevant information needs to be transmitted effectively among different nodes.

A method of interacting information between the performance detecting unit and the control processing unit through a signaling system is described in relevant technology, and is used to realize the adaptive dispersion compensation. As shown in FIG. 5, the performance detecting unit, the control processing unit and the dispersion adjusting unit are not located at a same node.

To sum up, in order to improve the dynamic and intellectualized development of the optical network, the performance detecting unit, the control processing unit and the dispersion adjusting unit which are relevant with the adaptive compensation system can be located at different nodes. Therefore, relevant information needs to be transmitted effectively among different nodes.

FIG. 1 is the diagram of the traditional optical communication system dispersion compensation method. At optical terminal state, the dispersion compensation fiber module is usually used after the wave is combined and before the wave is dispersed to compensate the dispersion of the multichannel optical signal of a DWDM system. At optical relay station, two-stage optical amplifiers are usually used, and the dispersion compensation fiber module is arranged between the two-stage amplifiers to realize multichannel dispersion compensation.

For the 40 Gb/s system and above, 10 Gb/s super-long system and dispersion dynamic change system, adaptive dispersion compensation technology is necessary to be used. The tunable dispersion compensation of the system consists of the optical domain dispersion compensation and the electrical domain dispersion compensation. In FIG. 2, by detecting the signal quality of the residual dispersion or relevant with the dispersion in the front of the receiver, such as the Q factor and so on, the adaptive dispersion compensation function is realized by feeding back the signals and controlling the tunable dispersion compensator in optical domain or electrical domain. In FIG. 3, by detecting the relevant signal performance at the back of the receiver, such as the error code rate and so on, the adaptive dispersion compensation function is realized by feeding back the signals and controlling the tunable dispersion compensator in optical domain or electrical domain.

FIG. 4 is the functional module diagram with various of adaptive dispersion compensation functions, consisting of three parts: the performance detecting unit, the control processing unit and the dispersion adjusting unit which are relevant with the dispersion. The diagram is suitable for the adaptive dispersion compensation module which can be realized at one node.

For the dynamic optical network, the three units can be located at different nodes. When the three units are located at different nodes, in order to realize the performance of the adaptive dispersion compensation, relevant information needs to be transmitted effectively among different nodes.

### SUMMARY OF THE PRESENT INVENTION

The present invention mainly aims at providing a adaptive dispersion compensation system and a method used in optical communication network to overcome the defect in prior art that each part of the adaptive dispersion compensator is required to be arranged at the same node.

In order to realize the aim, according to the first aspect of the present invention, the present invention provides a adaptive dispersion compensation system used in optical communication network. The adaptive dispersion compensation system comprises at least one performance detecting unit, for detecting relevant performances of the dispersion; at least one control processing unit, for generating control information according to the detected information from the at least one performance detecting unit; at least one dispersion adjusting unit. for compensating dispersion according to the control information from the at least one control processing unit; and an information transmission unit, which is connected among at least one performance detecting unit, at least one control processing unit and at least one dispersion adjusting unit which are arranged at different nodes, the information transmission unit is used for transmitting the detected information from at least one performance detecting unit to at least one control processing unit which is arranged at a different node, and is used for transmitting the control information from at least one control processing unit to at least one dispersion adjusting unit which is arranged at a different node.

The dispersion adjusting unit can be an tunable dispersion compensator, comprising the tunable dispersion compensator using CFBG (Chirped Fiber Bragg Grating), or the tunable dispersion compensator using G-T etalon interference technology, or the tunable dispersion compensator using microelectronic mechanical system technology, or the tunable dispersion compensator using PLC ring-shaped resonant cavity technology, or the device using multistage fixed dispersion compensator cascade connection technology and using different dispersion compensation value control technology through an optical switch.

The dispersion adjusting unit can be an tunable dispersion transmitter. The dispersion adjusting unit can be an tunable dispersion receiver.

The dispersion adjusting unit can be an tunable dispersion compensation receiver, comprising an electric domain tunable dispersion compensation receiver, or an optical domain tunable dispersion compensation receiver or the combination of the two.

Alternatively, one of at least one performance detecting unit, one of at least one control processing unit corresponding to the performance detecting unit, and one of at least one dispersion adjusting unit corresponding to the performance detecting unit are arranged respectively at different nodes. The detected information between the performance detecting unit and the control processing unit is transmitted by the information transmission unit. The control information between the control processing unit and the dispersion adjusting unit is transmitted by the information transmission unit.

Alternatively, one of at least one dispersion adjusting unit and one of at least one control processing unit corresponding to the dispersion adjusting unit are arranged at the same node. One of at least one performance detecting unit corresponding to the dispersion adjusting unit is arranged at a different node. The detected information between the performance detecting unit and the control processing unit is transmitted by the information transmission unit. The control information of the control processing unit is directly transmitted to the dispersion adjusting unit.

Alternatively, one of at least one performance detecting unit and one of at least one control processing unit corresponding to the performance detecting unit are arranged at the same node. One of at least one dispersion adjusting unit corresponding to the performance detecting unit is arranged at a different node. The detected information of the performance detecting unit is directly transmitted to the control processing unit. The control information between the control processing unit and the dispersion adjusting unit is transmitted by the information transmission unit.

Alternatively, a plurality of at least one performance detecting unit, a plurality of at least one control processing unit corresponding to the performance detecting unit, and a plurality of at least one dispersion adjusting unit corresponding to the performance detecting unit are respectively arranged at different nodes. The detected information between the plurality of the performance detecting unit and the plurality of the control processing unit corresponding to the performance detecting unit respectively is transmitted by the information transmission unit. The control information between the plurality of the control processing unit and the plurality of the dispersion adjusting unit corresponding to the control processing unit respectively is transmitted by the information transmission unit.

Alternatively, both a plurality of at least one performance detecting unit, and a plurality of at least one dispersion adjusting unit corresponding to the performance detecting unit correspond to one of at least one control processing unit and are intensively controlled by a control processing unit.

Alternatively, the information transmission unit realizes in-band information transmission through the overhead inside the optical path which needs to be compensated. Alternatively, the information transmission unit realizes information transmission through the public optical path irrelevant to the optical path which needs to be compensated. Alternatively, the information transmission unit realizes information transmission through the combination of the two paths: the overhead inside the optical path which needs to be compensated, and the public optical path irrelevant to the optical path which needs to be compensated.

The detected information can be the dispersion change information of the optical path which needs to be compensated over the whole optical transmission link.

The adaptive dispersion compensation system can be suitable for single channel or multichannel.

In order to achieve the aim, according to the second aspect of the present invention, the present invention provides a adaptive dispersion compensation method used in optical communication network. The adaptive dispersion compensation method comprises the following steps:

Detecting step for generating detected information through the dispersion relevant performances detected by at least one performance detecting unit;
Detected information transmission step for transmitting the detected information to at least one control processing unit;
Processing step for generating control information by at least one control processing unit according to the detected information;
Control information transmission step for transmitting the control information to at least one dispersion adjusting unit;
Compensation step for compensating the dispersion by at least one dispersion adjusting unit according to the control information.

Wherein, at the detected information transmission step and the control information transmission step, the information transmission unit is used to transmit the detected information from at least one performance detecting unit to at least one control processing unit which is arranged at a different node, and is used to transmit the control information from at least one control processing unit to at least one dispersion adjusting unit which is arranged at a different node.

At the compensation step, the tunable dispersion compensator can be used as the dispersion adjusting unit to compensate the dispersion.

Alternatively, at the detected information transmission step and the control information transmission step, the information transmission unit realizes in-band information transmission through the overhead inside the optical path which needs to be compensated. Alternatively, at the detected information transmission step and the control information transmission step, the information transmission unit realizes information transmission through the public optical path irrelevant to the optical path which needs to be compensated. Alternatively, at the detected information transmission step and the control information transmission step, the information transmission unit realizes information transmission through the combination of the two paths: overhead inside the optical path which needs to be compensated and the public optical path irrelevant to the optical path which needs to be compensated.

The detected information can be the dispersion change information of the optical path which needs to be compensated over the whole optical transmission link. The detected information can be the signal error code rate or signal Q factor or the information which reflects signal quality of the optical path which needs to be compensated at the receiving side of the optical transmission link.

The adaptive dispersion compensation method is suitable for the single channel system or multi-path system. The present invention can realize the adaptive dispersion compensation for the multi-path or the single channel system by using the technical proposal under the circumstance that the performance detecting unit, the control processing unit and the dispersion adjusting unit which are relevant to the adaptive dispersion compensation are arranged at different nodes.

### BRIEF DESCRIPTION OF THE DRAWINGS

The drawings in the specification provide a further understanding to the present invention and constitute a part of the application. The exemplary embodiments of the present invention and the explanation thereof are given thereafter by way of illustration only, and thus are not limitative of the present invention, and wherein:

FIG. 1 is a schematic view of a dispersion compensation method in traditional optical communication system;

FIG. 2 is a principle diagram of the adaptive dispersion compensation;

FIG. 3 is a principle diagram of another adaptive dispersion compensation;

FIG. 4 is a logic diagram of adaptive dispersion compensation;

FIG. 5 is a functional diagram of realizing adaptive dispersion compensation jointly through multiple nodes according to an embodiment of the present invention;

FIG. 6 is a diagram of a adaptive dispersion compensation system used in optical communication network according to the present invention;

FIG. 7 is a flow chart of a adaptive dispersion compensation method used in optical communication network according to the present invention;

FIG. 8 is a functional diagram of realizing adaptive dispersion compensation jointly through multiple nodes according to an another embodiment of the present invention;

FIG. 9 is a functional diagram of realizing adaptive dispersion compensation jointly through multiple nodes according to a yet another embodiment of the present invention;

FIG. 10 is a functional diagram of realizing multi-path adaptive dispersion compensation jointly through a plurality of node according to an another embodiment of the present invention;

FIG. 11 is a functional diagram of realizing multi-path adaptive dispersion compensation jointly through a plurality of nodes according to an a yet another embodiment of the present invention;

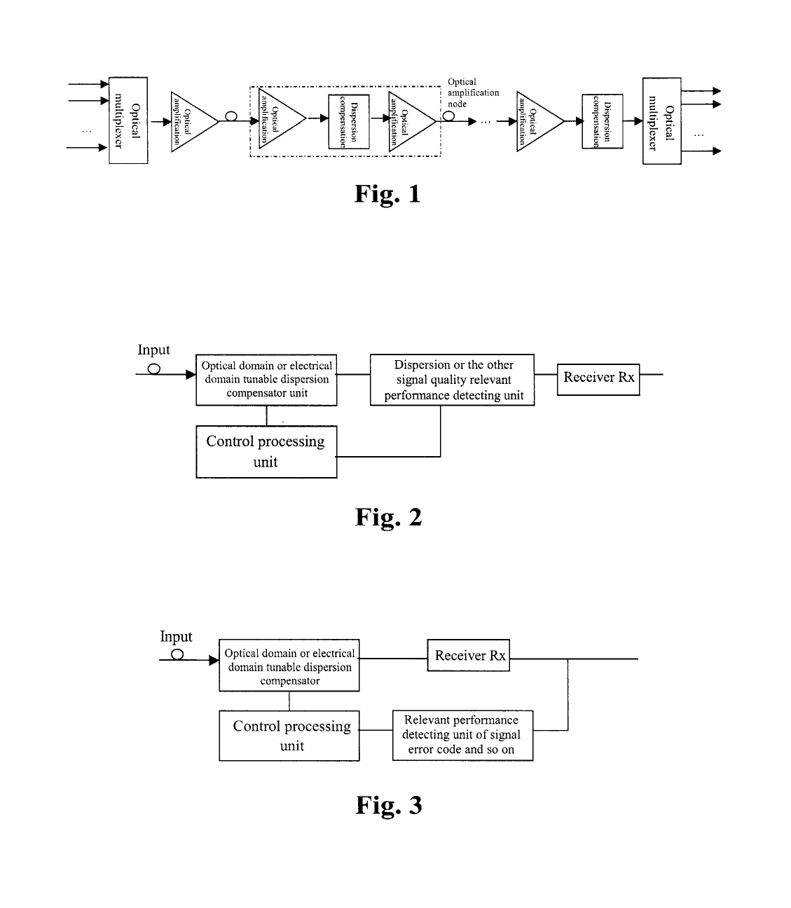

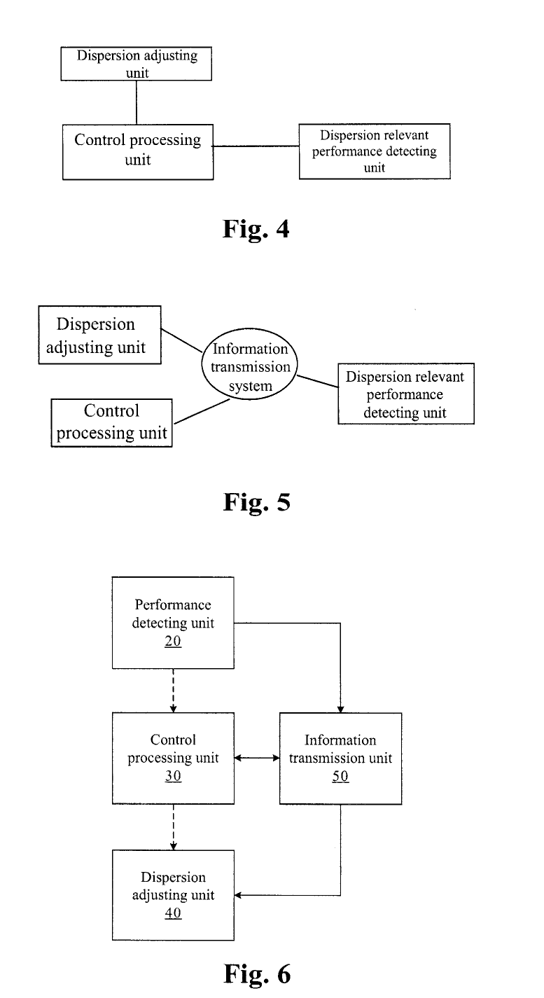

### DETAILED DESCRIPTION

The present invention will be detailed hereinafter and reference will be made to the drawings.

With reference to FIG. 6, the adaptive dispersion compensation system 10 used in optical communication network according to the present invention comprises: at least one performance detecting unit 20, for detecting dispersion relevant performances; at least one control processing unit, for generating the control information based on the detected information from at least one performance detecting unit 20; at least one dispersion adjusting unit 40, for compensating dispersion based on the control information from at least one control processing unit 30; and an information transmission unit 50, which is connected among at least one performance detecting unit 20, at least one control processing unit 30 and at least one dispersion adjusting unit 40 which are arranged at different nodes, the information transmission unit is used for transmitting the detected information from at least one performance detecting unit 20 to at least one control processing unit 30 which is arranged at a different node, and is used for transmitting the control information from at least one control processing unit 30 to at least one dispersion adjusting unit 40 which is arranged at a different node.

The dispersion adjusting unit 40 can be an tunable dispersion compensator, comprising the tunable dispersion compensator using CFBG (Chirped Fiber Bragg Grating), or the tunable dispersion compensator using G-T etalon interference technology, or the tunable dispersion compensator using microelectronic mechanical system technology, or the tunable dispersion compensator using PLC ring-shaped resonant cavity technology, or the device using multistage fixed dispersion compensator cascade connection technology and using different dispersion compensation value control technology through an optical switch.

The dispersion adjusting unit 40 can be a tunable dispersion transmitter.

The dispersion adjusting unit 40 can be a tunable dispersion receiver.

The dispersion adjusting unit 40 can be a tunable dispersion compensation receiver which can be an electric domain tunable dispersion compensation receiver, or an optical domain tunable dispersion compensation receiver or the combination of both.

Alternatively, one of at least one performance detecting unit 20, one of at least one control processing unit 30 corresponding to the performance detecting unit, and one of at least one dispersion adjusting unit 40 corresponding to the performance detecting unit are arranged respectively at different nodes. The detected information between the performance detecting unit 20 and the control processing unit 30 is transmitted by the information transmission unit 50. The control information between the control processing unit 30 and the dispersion adjusting unit 40 is transmitted by the information transmission unit 50.

Alternatively, one of at least one dispersion adjusting unit 40 and one of at least one control processing unit 30 corresponding to the dispersion adjusting unit are arranged at the same node. One of at least one performance detecting unit 20 corresponding to the dispersion adjusting unit is arranged at a different node. The detected information between the performance detecting unit 20 and the control processing unit 30 is transmitted by the information transmission unit 50. The control information of the control processing unit 30 is directly transmitted to the dispersion adjusting unit 40.

Alternatively, one of at least one performance detecting unit 20 and one of at least one control processing unit 30 corresponding to the performance detecting unit are arranged at the same node. One of at least one dispersion adjusting unit 40 corresponding to the performance detecting unit is arranged at a different node. The detected information of the performance detecting unit 20 is directly transmitted to the control processing unit 30. The control information between the control processing unit 30 and the dispersion adjusting unit 40 is transmitted by the information transmission unit 50.

Alternatively, a plurality of at least one performance detecting unit 20, a plurality of at least one control processing unit 30 corresponding to the performance detecting unit, and a plurality of at least one dispersion adjusting unit 40 corresponding to the performance detecting unit are respectively arranged at different nodes. The detected information between the plurality of the performance detecting unit 20 and the plurality of the control processing unit 30 corresponding to the performance detecting unit respectively is transmitted by the information transmission unit 50. The control information between the plurality of the control processing unit 30 and the plurality of the dispersion adjusting unit 40 corresponding to the control processing unit respectively is transmitted by the information transmission unit 50.

Alternatively, both a plurality of at least one performance detecting unit 20 and a plurality of at least one dispersion adjusting unit 40 corresponding to the performance detecting unit correspond to one of at least one control processing unit 30 and are intensively controlled by a control processing unit 30.

Alternatively, the information transmission unit 50 realizes in-band information transmission through the overhead inside the optical path which needs to be compensated. Alternatively, the information transmission unit 50 realizes information transmission through the public optical path irrelevant to the optical path which needs to be compensated. Alternatively, the information transmission unit 50 realizes information transmission through the combination of the two paths: the overhead inside the optical path which needs to be compensated, and the public optical path irrelevant to the optical path which needs to be compensated.

The detected information can be the dispersion change information of the optical path which needs to be compensated over the whole optical transmission link.

The adaptive dispersion compensation system can be suitable for single channel or multichannel.

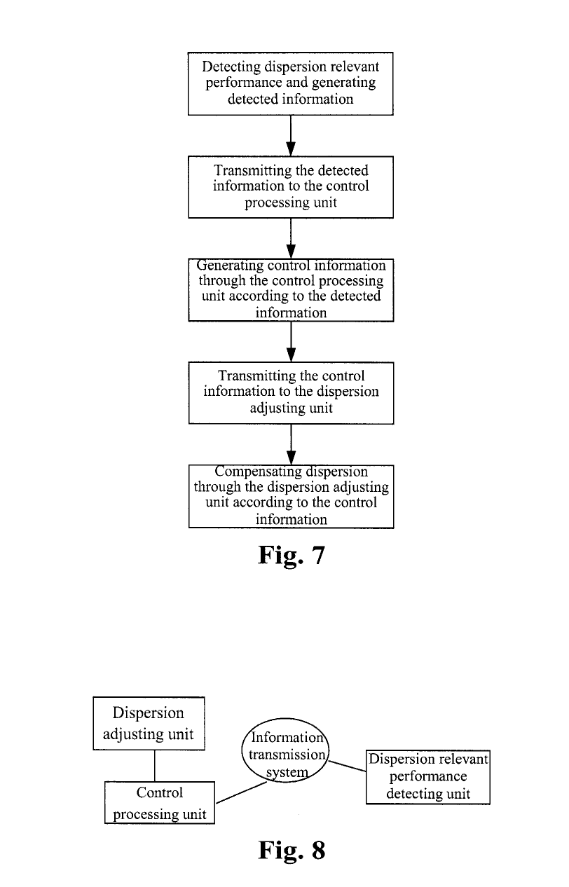

With reference to FIG. 7, the adaptive dispersion compensation method used in optical communication network according to the present invention comprises the following steps:

Detecting step for generating the detected information through the dispersion relevant performances detected by at least one performance detecting unit;
Detected information transmission step for transmitting the detected information to at least one control processing unit;
Processing step for generating control information by at least one control processing unit according to the detected information;
Control information transmission step for transmitting the control information to at least one dispersion adjusting unit;
Compensation step for compensating the dispersion by at least one dispersion adjusting unit according to the control information.

Wherein, at the detected information transmission step and the control information transmission step, the information transmission unit is used to transmit the detected information from at least one performance detecting unit to at least one control processing unit which is arranged at a different node, and is used to transmit the control information from at least one control processing unit to at least one dispersion adjusting unit which is arranged at a different node.

At the compensation step, the tunable dispersion compensator can be used as the dispersion adjusting unit to compensate the dispersion.

Alternatively, at the detected information transmission step and the control information transmission step, the information transmission unit realizes in-band information transmission through the overhead inside the optical path which needs to be compensated. Alternatively, at the detected information transmission step and the control information transmission step, the information transmission unit realizes information transmission through the public optical path irrelevant to the optical path which needs to be compensated. Alternatively, at the detected information transmission step and the control information transmission step, the information transmission unit realizes information transmission through the combination of the two paths: the overhead inside the optical path which needs to be compensated and the public optical path irrelevant to the optical path which needs to be compensated.

The detected information can be the dispersion change information of the optical path which needs to be compensated over the whole optical transmission link.

The detected information can be the signal error code rate or signal Q factor or the information which reflects signal quality of the optical path which needs to be compensated at the receiving side of the optical transmission link.

The adaptive dispersion compensation method is suitable for the single channel system or multichannel system.

The present invention relates to a dispersion compensation method used in optical transmission system, more particularly, relates to an apparatus and a method which realize adaptive dispersion compensation. The present invention provides a adaptive dispersion compensation method and an apparatus which can compensate system dispersion for the intellectualized optical network in a distributed way. The technical solution of the present invention can refer to FIG. 5 to FIG. 9. The present invention comprises the following steps:

(1) The apparatus comprises the performance detecting unit, the control processing unit, the dispersion adjusting unit and the information transmission unit;

(2) The single channel or multichannel dispersion compensation can be realized by tunable dispersion compensator;

(3) The control processing unit can adopt a certain strategy to control the dispersion compensation performance of the tunable dispersion compensator according to the obtained dispersion relevant information.

(4) The information transmission unit is used for real-time transmitting the changes of the dispersion of each path and line or the dispersion of optical network nodes, and/or the information between the control unit and the dispersion adjusting unit.

The core content of the present invention is that the information transmission system which shares a same optical path or has independent path is used to transmit the detected or control information relevant to dispersion compensation to realize the adaptive dispersion compensation.

FIG. 5 to FIG. 11 are some embodiment of the present invention, which can be applied in single channel system and multichannel system.

In FIG. 5, the information among the performance detecting unit, the control processing unit and the dispersion adjusting unit which are arranged at different nodes is transmitted by the information transmission system. In FIG. 8, the control processing unit and the dispersion adjusting unit are arranged at the same node, and the performance detecting unit is arranged at another node. The dispersion relevant performance detected information is transmitted to the control processing unit by the information transmission system.

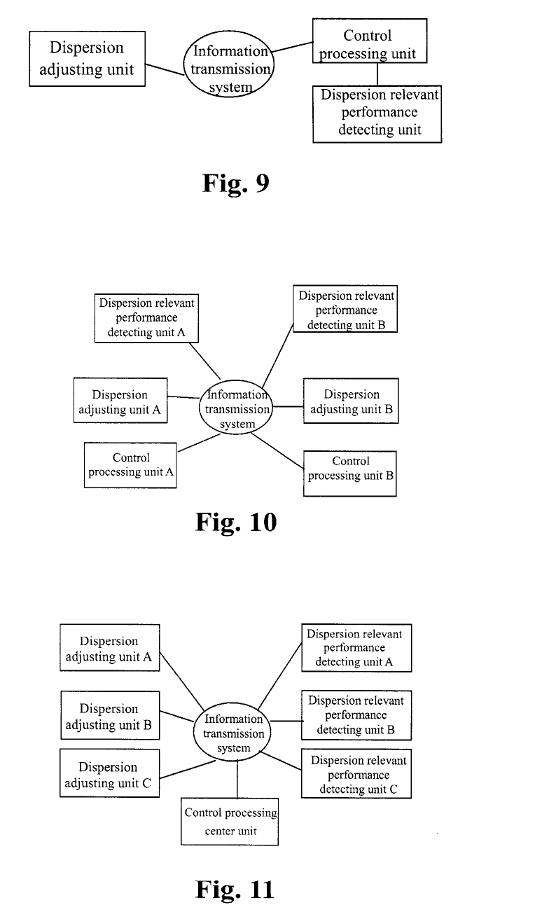

In FIG. 9, the control processing unit and the performance detecting unit are arranged at the same node, and the dispersion adjusting unit is arranged at another node. The dispersion relevant control information is transmitted from the control processing unit to the dispersion adjusting unit. FIG. 10 is an example of independent control processing unit. A plurality of control processing units and a plurality of performance detecting units are arranged at the same node and a plurality of dispersion adjusting units are arranged at different nodes. The dispersion relevant detected and control information is transmitted among respective control processing unit, performance detecting unit and dispersion adjusting unit by the information transmission system. FIG. 11 is an illustrative diagram of a centralized control processing unit.

When the topology of the optical path changes or the dispersion index of some part on path or some part of the subsystem changes, the dispersion relevant information will be transmitted and the relevant information will be transmitted to the control unit. According to a certain strategy, the control unit can calculate the dispersion value which the tunable dispersion compensator needs to set. The relevant information is transmitted to the dispersion adjusting unit to realize the dispersion adaptive regulation.

The dispersion compensation of the tunable dispersion compensator can be realized by many strategies. The simplest strategy is to adjust the dispersion compensation value of the dispersion compensator, ensuring that the residual dispersion value C_{residual} after the dispersion is compensated is controlled within a certain range of Cₘᵢₙ-Cₘₐₓ.

$${C}_{residual} = {C}_{Tx} - {C}_{adj} - {\sum }_{i} {C}_{Li} - {\sum }_{i} {C}_{NLi} {\sum }_{j} {C}_{ONj}$$

$${C}_{min} \leq {C}_{residual} \leq {C}_{max}$$

The information transmission system can be realized in many ways, and the basic function thereof is to realize the relevant information transmission among the nodes. The physical path of the information transmission system can utilize some overhead inside the optical path which need to be compensated to build an in-band information transmission path, and can also utilize the public optical path which is irrelevant to the optical path which needs to be compensated. The information transmission among different nodes can be realized by mature communication protocol and also can be realized by private protocol or method.

Such as for long-distance 40 Gb/s SDH system, the DCM with fixed dispersion value can be utilized to make coarse dispersion compensation, and the adaptive dispersion compensation system is utilized to compensate the residual dispersion. For the adaptive dispersion compensator used in long-distance 40 Gb/s SDH system, the dispersion detecting unit thereof is arranged at the receiving side, and the dispersion adjusting unit and the control unit thereof are arranged at the transmitting side or at the receiving side. When the dispersion adjusting unit is arranged at the transmitting side, the control information needs to be transmitted from the receiving side to the transmitting side. STM-256 or the unused overhead bytes of OTU3 can be utilized to transmit dispersion compensation relevant control information.

For the WDM optical transmission system, the optical supervisory path can be utilized as the physical path. Relevant communication protocol can be utilized to realize the transmission of dispersion relevant information.

The descriptions above are only preferable embodiments of the present invention, which are not used to restrict the present invention. For those skilled in the art, the present invention may have various changes and variations. Any amendments, equivalent substitutions, improvements etc. within the spirit and principle of the present invention are all concluded in the scope of protection of the present invention.

1. A adaptive dispersion compensation system for optical communication network, characterized in that the system comprises:
at least one performance detecting unit for detecting a dispersion relevant performance;
at least one control processing unit for generating control information according to the detected information from the at least one performance detecting unit;
at least one dispersion adjusting unit for compensating dispersion according to the control information from the at least one control processing unit; and
an information transmission unit connected among the at least one performance detecting unit, the at least one control processing unit and the at least one dispersion adjusting unit which are located at different nodes, for transmitting the detected information from the at least one performance detecting unit to the at least one control processing unit located at a different node, and for transmitting the control information from the at least one control processing unit to the at least one dispersion adjusting unit located at a different node.

2. The adaptive dispersion compensation system according to claim 1, wherein the at least one dispersion adjusting unit is an tunable dispersion compensator which can be the one employing Chirped Fiber Bragg Grating, or the one employing G-T etalon interference technology, or the one employing microelectronic mechanical system technology, or the one employing PLC ring-shaped resonant cavity technology, or the device employing multistage fixed dispersion compensators in cascade connection and as well as the technology accomplishing different dispersion compensation values by the control of an optical switch.

3. The adaptive dispersion compensation system according to claim 1, wherein the at least one dispersion adjusting unit is a transmitter capable of accommodating dispersion.

4. The adaptive dispersion compensation system according to claim 1, wherein the at least one dispersion adjusting unit is a receiver capable of adjusting dispersion.

5. The adaptive dispersion compensation system according to claim 1, wherein the at least one dispersion adjusting unit is an tunable dispersion compensation receiver, which can be an electric domain tunable dispersion compensation receiver, or an optical domain tunable dispersion compensation receiver, or the combination of the both.

6. The adaptive dispersion compensation system according to claim 1, wherein one of the at least one performance detecting unit, one of the at least one control processing unit corresponding thereto, and one of the at least one dispersion adjusting unit corresponding thereto are arranged respectively at different nodes, the detected information between the one performance detecting unit and the one control processing unit is transmitted by the information transmission unit, and the control information between the one control processing unit and the one dispersion adjusting unit is transmitted by the information transmission unit.

7. The adaptive dispersion compensation system according to claim 1, wherein one of the at least one dispersion adjusting unit and one of the at least one control processing unit corresponding thereto are arranged at the same node, one of the at least one performance detecting unit corresponding thereto is arranged at a different node, the detected information between the one performance detecting unit and the one control processing unit is transmitted by the information transmission unit, and the control information of the one control processing unit is directly transmitted to the dispersion adjusting unit.

8. The adaptive dispersion compensation system according to claim 1, wherein one of the at least one performance detecting unit and one of the at least one control processing unit corresponding thereto are arranged at the same node, one of the at least one dispersion adjusting unit corresponding thereto is arranged at a different node, the detected information of the one performance detecting unit is directly transmitted to the one control processing unit, and the control information between the one control processing unit and the one dispersion adjusting unit is transmitted by the information transmission unit.

9. The adaptive dispersion compensation system according to claim 1, wherein a plurality of the at least one performance detecting unit, a plurality of the at least one control processing unit corresponding thereto, and a plurality of the at least one dispersion adjusting unit corresponding thereto are respectively arranged at different nodes, the detected information between the plurality of the performance detecting unit and the plurality of the control processing unit corresponding respectively thereto is transmitted by the information transmission unit, the control information between the plurality of the control processing unit and the plurality of the dispersion adjusting unit corresponding respectively thereto is transmitted by the information transmission unit.

10. The adaptive dispersion compensation system according to claim 1, wherein a plurality of the at least one performance detecting unit and a plurality of the at least one dispersion adjusting unit corresponding thereto correspond to one of the at least one control processing unit and are centralizilly controlled by the one control processing unit.

11. The adaptive dispersion compensation system according to claim 1, wherein the information transmission unit realizes in-band information transmission through the overhead inside the optical path to be compensated.

12. The adaptive dispersion compensation system according to claim 1, wherein the information transmission unit realizes information transmission through the public optical path irrelevant to the optical path which needs to be compensated.

13. The adaptive dispersion compensation system according to claim 1, wherein the information transmission unit realizes information transmission through the combination of the overhead inside the optical path which needs to be compensated and the public optical path irrelevant to the optical path which needs to be compensated.

14. The adaptive dispersion compensation system according to claim 1, wherein the detected information can be the dispersion change information of the optical path to be compensated over the whole optical transmission link.

15. The adaptive dispersion compensation system according to claim 1, wherein the adaptive dispersion compensation system is adaptable to a single channel or a multichannel.

16. An adaptive dispersion compensation method for optical communication network, characterized in that the method comprises the following steps:
a detecting step for generating detected information through the detection of the dispersion relevant performances by means of at least one performance detecting unit;
a detected information transmission step for transmitting the detected information to at least one control processing unit;
a processing step for generating control information by means of the at least one control processing unit according to the detected information;
a control information transmission step for transmitting the control information to at least one dispersion adjusting unit; and
a compensation step for compensating the dispersion by means of the at least one dispersion adjusting unit according to the control information,
wherein, at the detected information transmission step and the control information transmission step, the detected information are transmitted from the at least one performance detecting unit to the at least one control processing unit which is arranged at a different node, and the control information are transmitted from the at least one control processing unit to the at least one dispersion adjusting unit which is arranged at a different node, by means of the information transmission unit.

17. The adaptive dispersion compensation method according to claim 16, wherein at the compensation step, an tunable dispersion compensator can be used as the dispersion adjusting unit to compensate the dispersion.

18. The adaptive dispersion compensation method according to claim 16, wherein at the detected information transmission step and the control information transmission step, the in-band information transmission is accomplished by means of the information transmission unit using the overhead inside the optical path to be compensated.

19. The adaptive dispersion compensation method according to claim 16, wherein at the detected information transmission step and the control information transmission step, the information transmission unit realizes information transmission through the public optical path irrelevant to the optical path to be compensated.

20. The adaptive dispersion compensation method according to claim 16, wherein at the detected information transmission step and the control information transmission step, the information transmission unit realizes information transmission through the combination of the two paths: the overhead inside the optical path which needs to be compensated, and the public optical path irrelevant to the optical path which needs to be compensated.

21. The adaptive dispersion compensation method according to claim 16, wherein the detected information can be the dispersion change information of the optical path to be compensated over the whole optical transmission link.

22. The adaptive dispersion compensation method according to claim 16, wherein the detected information can be the signal bit error rate or signal Q factor or the information which reflects signal quality of the optical path to be compensated at the receiving side of the optical transmission link.

23. The adaptive dispersion compensation method according to claim 16, wherein the adaptive dispersion compensation method is suitable for the single channel system or the multichannel system.
